(19) United States
(12) Patent Application Publication
(10) Pub. No.: US 2010/0042432 A1
(43) Pub. Date: Feb. 18, 2010

(54) THERAPY DISCHARGE RECONCILIATION

(75) Inventors: CHARLES SCHNEIDER, TRIMBLE, MO (US); ELIZABETH BARLOW, KANSAS CITY, MO (US); KHALOD KELANTAN PELEGRIN, LEAWOOD, KS (US)

Correspondence Address: SHOOK, HARDY & BACON L.L.P.;Intellectual Property Department, 2555 GRAND BOULEVARD, KANSAS CITY, MO, 64108-2613, US

(73) Assignee: CERNER INNOVATION, INC., OVERLAND PARK, KS (US)

(21) Appl. No.: 12/190,378

(22) Filed: Aug. 12, 2008

(51) Int. Cl. G06Q 50/00

(52) U.S. Cl. 705/3; 705/2

(57) ABSTRACT

Systems, methods, and computer-readable media for displaying therapy groupings and individual therapies for a patient on a display. At least one therapy grouping area comprising one or more therapy groupings is provided for a patient being discharged from a current care venue. The therapy grouping comprises a therapy prescribed for or taken by the patient prior to visiting the current care venue associated with a therapy the patient was prescribed while visiting the current care venue. At least one previous therapy area is provided that includes an individual therapy prescribed for the patient prior to visiting a current care venue that has not been associated with a therapy the patient was prescribed while visiting the current care venue and at least one current therapy area comprising an individual therapy prescribed for the patient while visiting the current care venue that has not been associated with a therapy prescribed for or taken by the patient prior to visiting the current care venue. At least one interactive user input area is provided allowing a user to enter a discharge input for at least one therapy grouping.

### SUMMARY

In one embodiment of the present invention, a computer-implemented method for associating one or more prior therapies with one or more current therapies is provided. The identification of one or more therapies a patient was taking or prescribed prior to visiting a current care venue is accessed. One or more therapies the patient is taking or has been prescribed at the current care venue for the current care venue visit are accessed. Input is received that one of the one or more prior therapies for the patient corresponds with one of the one or more current therapies for the patient. In response to receiving the input, the corresponding prior therapy is associated with the corresponding current therapy. The association of the corresponding prior therapy and the corresponding current care venue therapy is stored for the patient.

In yet another embodiment, a computer-implemented method for creating new therapy orders for one or more prior therapies is provided. One or more therapies a patient was taking or prescribed prior to visiting a current care venue are accessed. The one or more therapies the patient was taking prior to visiting the current care venue are displayed on an interactive graphical user interface. Input is received from the graphical user interface to create one or more therapy orders for the current care venue for one or more of the prior therapies for the patient. In response to receiving the input, one or more therapy orders for the current care venue for the one or more of the prior therapies for the patient are created. The one or more therapy orders for the current care venue for the one or more of the prior therapies for the patient are stored.

In still another embodiment, a computer-implemented method for generating discharge instructions for a therapy grouping is provided. A therapy grouping for a patient being discharged from a current care venue is displayed. The therapy grouping comprises a therapy prescribed for or taken by the patient prior to visiting a current care venue and an associated therapy the patient is taking or has been prescribed by the current care venue for the current care venue visit. A discharge input is received from a user for the therapy grouping. Discharge instructions for the therapy grouping are generated for the patient based on the discharge input received and stored.

In yet another embodiment, a user interface embodied on one or more computer-storage media is provided for displaying therapy groupings and individual therapies for a patient on a display. The user interface comprises at least one therapy grouping area comprising one or more therapy groupings for a patient being discharged from a current care venue. The therapy grouping comprises a therapy prescribed for or taken by the patient prior to visiting the current care venue associated with a therapy the patient was prescribed while visiting the current care venue. The user interface further comprises at least one previous therapy area comprising an individual therapy prescribed for the patient prior to visiting a current care venue that has not been associated with a therapy the patient was prescribed while visiting the current care venue and at least one current therapy area comprising an individual therapy prescribed for the patient while visiting the current care venue that has not been associated with a therapy prescribed for or taken by the patient prior to visiting the current care venue. The user interface comprises at least one interactive user input area allowing a user to enter a discharge input for at least one therapy grouping.

### BRIEF DESCRIPTION OF THE DRAWINGS

Embodiments are described in detail below with reference to the attached drawing figures, wherein:

FIG. 1 is a block diagram of an exemplary computing environment suitable for use in implementing embodiments of the present invention;

FIG. 2 is an exemplary computer system for associating a previous therapy and current therapy for a patient in accordance with an embodiment of the present invention;

FIG. 3 is a flow diagram illustrating method for associating a previous therapy and current therapy for a patient in accordance with an embodiment of the present invention;

FIG. 4 is an exemplary computer system for generating discharge instructions for previous therapies and current therapies for a patient in accordance with an embodiment of the present invention;

FIG. 5 is a flow diagram illustrating a method for generating discharge instructions for previous therapies and current therapies for a patient in accordance with an embodiment of the present invention;

FIGS. 6 and 7 are illustrative graphical user interface displays of previous therapies and current therapies for a patient in accordance with embodiments of the present invention;

FIG. 8 is an illustrative graphical user interface display of previous therapies and current therapies before a patient's discharge from the current care venue in accordance with an embodiment of the present invention; and

FIG. 9 is an exemplary computer system for storing and displaying patient therapy reconciliation in accordance with an embodiment of the present invention.

### DETAILED DESCRIPTION

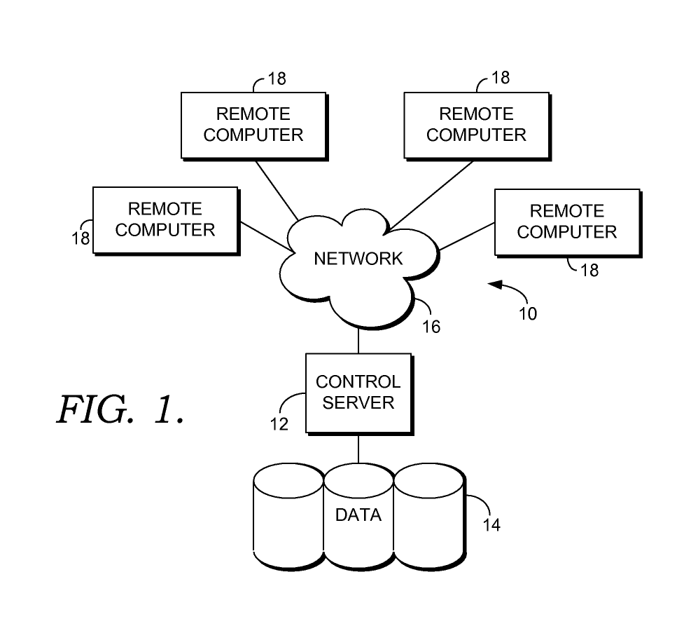

With reference to FIG. 1, an exemplary medical information system for implementing embodiments of the invention includes a general purpose-computing device in the form of server 22. Components of server 22 may include, but are not limited to, a processing unit, internal system memory, and a suitable system bus for coupling various system components, including database cluster 24 to the control server 22. The system bus may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

Server 22 typically includes therein or has access to a variety of computer readable media, for instance, database cluster 24. Computer readable media can be any available media that can be accessed by server 22, and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information, such as computer readable instructions, data structures, program modules or other data. Computer storage media includes, but is not limited to, RAM, ROM, EEPROM, flash memory or other memory technology, CD-ROM, digital versatile disks (DVD), or other optical disk storage, magnetic cassettes, magnetic tape, magnetic disk storage, or other magnetic storage devices, or any other medium which can be used to store the desired information and which can be accessed by server 22. By way of example, and not limitation, communication media includes wired media, such as a wired network or direct-wired connection, and wireless media such as acoustic, RF, infrared and other wireless media. Combinations of any of the above should also be included within the scope of computer readable media.

The computer storage media, including database cluster 24, discussed above and illustrated in FIG. 1, provide storage of computer readable instructions, data structures, program modules, and other data for server 22. Server 22 may operate in a computer network 26 using logical connections to one or more remote computers 28. Remote computers 28 can be located at a variety of locations in a medical or research environment, for example, but not limited to, clinical laboratories, hospitals, other inpatient settings, a clinician's office, ambulatory settings, medical billing and financial offices, hospital administration, veterinary environment and home health care environment. Clinicians and caregivers include, but are not limited to, the treating physician, specialists such as surgeons, radiologists and cardiologists, emergency medical technologists, discharge planners, care planners, physician's assistants, nurse practitioners, nurses, nurse's aides, pharmacists, dieticians, veterinarians and the like. The remote computers may also be physically located in non-traditional medical care environments so that the entire health care community is capable of integration on the network. Remote computers 28 may be a personal computer, server, router, a network PC, a peer device, other common network node or the like, and may include some or all of the elements described above relative to server 22. Computer network 26 may be a local area network (LAN) and/or a wide area network (WAN), but may also include other networks. Such networking environments are commonplace in offices, enterprise-wide computer networks, intranets and the Internet. When utilized in a WAN networking environment, server 22 may include a modem or other means for establishing communications over the WAN, such as the Internet. In a networked environment, program modules or portions thereof may be stored in server 22, or database cluster 24, or on any of the remote computers 28. For example, and not limitation, various application programs may reside on the memory associated with any one or all of remote computers 28. It will be appreciated that the network connections shown are exemplary and other means of establishing a communications link between the computers may be used.

A user may enter commands and information into server 22 or convey the commands and information to the server 22 via remote computers 28 through input devices, such as keyboards, pointing devices, commonly referred to as a mouse, trackball, or touch pad. Other input devices may include a microphone, scanner, or the like. Server 22 and/or remote computers 28 may have any sort of display device, for instance, a monitor. In addition to a monitor, server 22 and/or computers 28 may also include other peripheral output devices, such as speakers and printers.

Although many other internal components of server 22 and computers 28 are not shown, those of ordinary skill in the art will appreciate that such components and their interconnection are well known. Accordingly, additional details concerning the internal construction of server 22 and computer 28 need not be disclosed in connection with the present invention. Although the method and system are described as being implemented in a LAN operating system, one skilled in the art would recognize that the method and system can be implemented in any system.

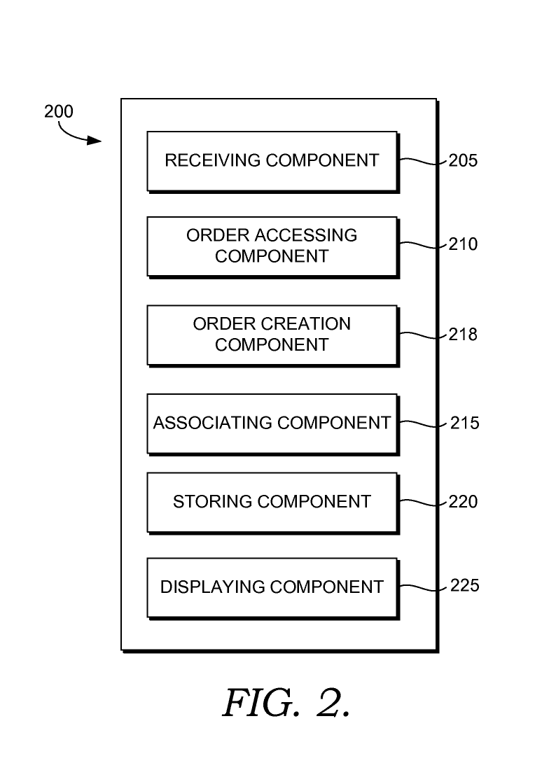

As previously set forth, embodiments of the present invention relate to computing systems for associating previous therapies for a patient with current therapies ordered by the current care venue for the patient. With reference to FIG. 2, a block diagram is illustrated that shows exemplary computing system architecture configured for associating previous therapies and current care venue therapies for a patient in accordance with an embodiment of the present invention. Therapies include any form of treatment for any problem, diagnosis, illness or disorder including, but not limited to, prescription medications, over the counter medications, physical therapy treatment, occupational therapy treatment, respiratory therapy treatment, speech therapy treatment, and the like. It will be understood and appreciated by those of ordinary skill in the art that the computing system architecture shown in FIG. 2 is merely an example of one suitable computing system and is not intended to suggest any limitation as to the scope of use or functionality of the present invention. Neither should the computing system architecture be interpreted as having any dependency or requirement related to any single module/component or combination of modules/components.

The computing system includes a therapy continuity module 200. Therapy continuity module 200 creates a continuum of therapy link by creating associations between the previous therapies for a patient, such as home medications, and current therapies for the patient at the current care venue. Therapy continuity module 200 displays the therapies, including medications that a patient has been taking, has been prescribed, and/or is currently taking. The module allows a caregiver to raise the level of care from managing individual therapies in one venue of care to managing a patient's therapies across multiple venues of care, including the home.

Furthermore, the user can create a relationship that associates orders for therapies from one venue of care with orders from another venue of care-the association representing the same therapy. This helps monitor a patient's therapies as users, caregivers and venues of care change over time. Furthermore, the continuum of therapy module allows a user, such as a caregiver, to communicate why the patient has been prescribed or is taking some therapies and how long the patient has been prescribed or taking those therapies.

A care venue includes inpatient facilities such as hospitals, rehabilitation centers, nursing care facilities, assisted living facilities, birthing centers, and outpatient facilities such as ambulatory care facilities, surgical centers, physician offices, clinics, a home or residence and the like. Previous therapies include therapies that the patient was prescribed and/or taking prior to the patient's current visit or admission to the current care venue. Previous therapies are not prescribed or given by the current care venue for the patient's current visit. For example, previous care venue therapies may include therapies prescribed by other care venues and physicians, or by the current care venue prior to the patient's current admission or visit to the current care venue; and the therapies the patient is currently taking and/or should be taking. These include prescribed medications from a patient's doctor for use at home and medications prescribed at a different care venue such as a nursing facility. In one embodiment, prescriptions for therapy from a patient's previous visit to the care venue are considered previous therapies. The current therapies for the patient are therapies the patient is prescribed and/or taking during the patient's current visit or admission to the current care venue. For example, the previous therapies may include home medications prescribed by the patient's physician and the current therapies may be inpatient medication orders for the facility that the patient has been currently admitted, such as a hospital.

A caregiver requires knowledge of previous therapies for the patient for treatment of the patient and/or to complete a medication reconciliation process. Medication reconciliation is a process for obtaining and documenting a complete list of a patient's medications upon the patient's admission to a care venue. A complete list of patient medications can then be communicated to the next provider of service. The Joint Commission on Accreditation of Health Care Organizations (JCAHO) has prioritized the accurate and complete reconciliation of medications across the continuum of care. JCAHO goals require that a reconciliation of medications is completed within a specified time period such as 24 hours from admission of the patient.

Therapy continuity module 200 allows a user to create an association between a previous therapy for a patient and a current therapy for the patient at the current care venue to establish a continuum of therapy link that may be used for treatment of the patient and/or in the medication reconciliation process. The therapy continuity module 200 is configured for continuing to create associations between therapy orders even after medication reconciliation has been performed for a specified time after admission of the patient to accommodate for information learned after the initial medication reconciliation process. Therapy continuity module 200 may reside on one or more computing devices, such as, for example, computing device 100 described above with reference to FIG. 1. By way of example only and not limitation, computing devices may be a server, personal computer, desktop computer, laptop computer, handheld device, mobile handset, consumer electronic device, or the like. It should be noted, however, that embodiments are not limited to implementation on such computing devices, but may be implemented on any a variety of different types of computing devices within the scope of embodiments thereof.

Therapy continuity module 200 comprises previous therapy identification component 205, order accessing component 210, associating component 215, storing component 220 and displaying component 225. Previous therapy identification component 205 receives or accesses one or more therapies prescribed for the patient or that the patient has been taking prior to visiting or being admitted to the current care venue. By way of example, a caregiver, such as a nurse, may electronically enter home medications for patient upon admission to the current care venue or later upon learning of the information while the patient is being treated at the current care venue. For example, the caregiver may ask the patient, the patient's family or patient's friends to identify the medications the patient has been taking (and/or has been prescribed) before the patient was admitted to the current care venue and input these into the patient's electronic medical record. The previous therapy information may be gathered and entered as part of the medication reconciliation process. In another embodiment, the previous therapies may be electronically transferred to the therapy continuum module 200. In one embodiment, previous therapies entered or electronically transferred to the therapy continuum module 200 constitute medication orders.

Order accessing component 210 accesses therapy orders for the patient for the current care venue that the patient is currently being treated or has been admitted. The order accessing component 210 accesses the patient's electronic medical to determine the therapy orders for the patient at the current care venue. Examples of the orders include, but are not limited to, types of treatment or testing to be performed for a patient, in some instances by a caregiver, including, medication orders, laboratory orders, testing, surgery orders, procedure orders and the like.

Displaying component 225 is configured for electronically displaying previous therapies for the patient and the current therapies for the patient at the current care venue. Displaying component 225 also is configured for displaying previous therapies for the patient associated with current therapies for the current care venue.

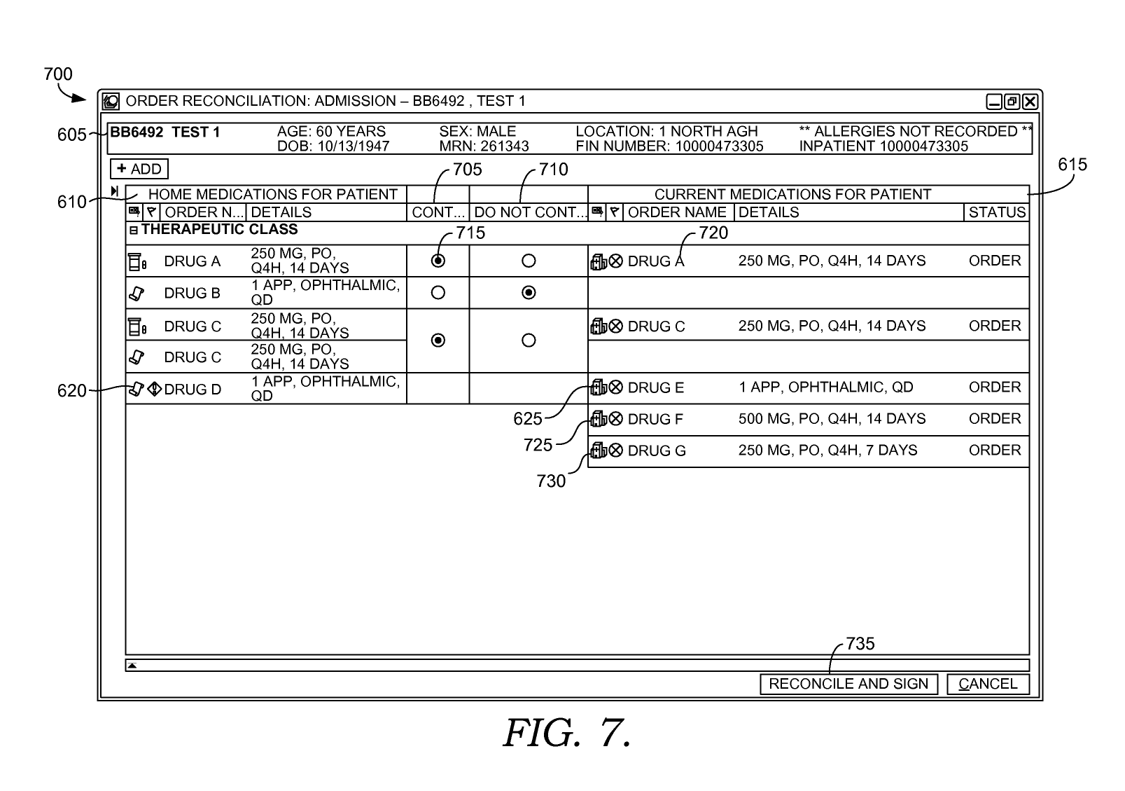

With reference to FIGS. 6 and 7, illustrative interactive screen displays 600 and 700 are shown. In accordance with an embodiment of the present invention, generally, exemplary user interfaces 600 and 700 comprise a previous therapy list area 610 and a current therapy list area 615. The previous therapy list area 610 and the current therapy list area 615 may be displayed anywhere within the graphical user interface and may be displayed simultaneously.

Previous therapy list area 610 is comprised of therapies prescribed for the patient prior to visiting or being admitted to the current care venue, including home medications. The therapies in the previous therapy list area 605 may be displayed in any order. For example, in previous therapy list area 610, the patient 605 having a patient identification number of BB6492 reported previously taking home medications: drug A, drug B, drug C and drug D. These medications that the patient was taking prior to treatment at the current care venue have been entered or received for the patient and are displayed on interactive screen display 600 by displaying component 225 of FIG. 2.

Current therapy area 610 comprises therapies, such as prescribed medications, for the patient for the current care venue. The current therapies for the patient in the current therapy list area 615 may be displayed in any sequence. For example, in the current medication list area 615, the patient is shown as having been prescribed Drug E 625 while visiting the current care venue. In one embodiment, the current medications are accessed from electronic orders for the patient for the current care venue. The current therapies are displayed on the interactive screen display 600 by displaying component 225 of FIG. 2.

Association component 215 associates one or more previous therapies with one or more current therapies for a patient. The association may be done utilizing a rules engine that automatically recognizes that one or more previous therapies correspond with one or more current therapy orders. In another embodiment, a caregiver determines whether there is an association between a previous therapy and a current therapy for the patient and inputs into the system an indication that the association exists.

With reference to FIG. 6, from user interface 600, a user may associate one or more previous therapies for a patient with one or more current therapies for the patient utilizing interactive graphical user interface 600. When a patient is admitted to a care venue, caregivers begin making decisions as to the patient's therapy needs. In order to make these decisions in an educated and safe manner, a caregiver needs to know what previous therapies the patient was taking and/or prescribed in the previous venue of care, including the home. The user interface 600 conveys this information in a readable manner that is therapeutically grouped to notify the user what the patient was previously taking and/or prescribed, is currently taking and/or prescribed at the current care venue and what unaddressed decisions need to be made. The caregiver may utilize this information to safely and accurately create the inpatient orders for therapies for the patient.

By providing a side-by-side view of previous and current therapies for the patient, visual cues are provided to the user to ascertain what the patient was taking and/or prescribed and what they currently are taking and/or prescribed. This information may then be displayed in a therapeutic grouping allowing the user to see what other medications are being taken within the same therapeutic grouping. This therapeutic grouping helps identify therapies that may be omitted, duplicated or conflicting with other therapies. The user interface 600 is also helpful when performing medication reconciliation when a caregiver must choose whether a patient should continue or discontinue previous therapies.

By way of example, for the patient 605, a user may select a home medication 610 and a current medication 615, and select the associate button 630 to group the two medications. There may be identical or nearly identical previous therapies and current therapies that are being used to treat the same problem and the user may choose to associate such therapies to one another. In another embodiment, as shown in FIG. 6, a current care venue medication prescription 625 may be a different medication from the previous medication 620 that is being used to treat the same problem. For example, the patient may have been taking acetaminophen as a previous therapy, and while the patient is admitted to the care venue has been prescribed and is taking ibuprofen as a current therapy. The user can choose to associate the different medications to show a continuum of therapy. By way of example, the user may choose to associate current care venue medication Drug E 625 and previous medication Drug D 620 as related therapies for treating the same problem. The association of Drug E 625 and Drug D is made by the system and stored.

Referring again to FIG. 2, if an existing current therapy does not correlate to a previous therapy of the patient, order creation component 218 allows for therapy orders for the current care venue to be created for previous therapies. With reference to FIG. 7, from user interface 700, a user may choose to continue 705 or discontinue 710 one or more previous therapy prescriptions 610 for a patient 605 via graphical user interface 700. By way of example, a user may select to continue a home medication 610 for the patient 605 by selecting “continue” 705 and create a current order 720 for the therapy. By way of example, a user may choose to continue 715 home medication drug A. Upon selecting to continue drug A, a current prescription 720 for the current care venue is shown. In one embodiment, the information for the current prescription order 720 is completed automatically by the computer system and then made available to the user for modification. The association of the previous drug A and the new current order for drug A is made by the system and stored. In another embodiment, as shown in FIG. 7, a user may select to discontinue 710 a previous therapy.

Orders for two additional therapies 725 and 730, not associated with any previous therapies, are displayed in graphical user interface 700. As can be seen in graphical user interface 700, new therapy orders for Drug F 725 and Drug G 730 have been prescribed for the patient and are not associated with any previous therapies for the patient. This provides a user with a clear picture of: previous therapies that have been entered into the system, current therapies that have been continued from a previous therapy, current therapies that have been associated with a previous therapy, and new current therapies ordered for the patient. This information may be used to reconcile previous and current therapies and for treating the patient.

Storing component 220 is configured for storing information associated with previous and current therapies for a patient. In various embodiments, such information may include, without limitation, current therapy orders for the patient; previous therapies for the patient; associations of previous therapy prescriptions and current venue therapy prescriptions; associations of previous therapy prescriptions and newly created therapy prescriptions for the current care venue; information regarding discontinuing a previous therapy during a patient's current stay in a care venue; information that previous medication was not continued during the patient's current stay; and information regarding the one or more users who made an association, created a new order for a previous therapy, decided not to continue a current therapy prescriptions and/or reconciled the therapies for the patient, and the reasons for such actions.

An exemplary storing component is depicted by data store 14 of FIG. 1. In embodiments, the storage component 210 is configured to be searchable for one or more of the items stored in association therewith. It will be appreciated by those of ordinary skill in the art that the information stored in the storage component 210 may be configurable and may include a variety of information relevant to therapy prescriptions. Further, though illustrated as a single, independent component, the storage component 210 may, in fact, be a plurality of storage devices, for instance a database cluster, portions of which may reside on the server 12 of FIG. 1, one or more end user devices 18, another external computing device (not shown), and/or any combination thereof.

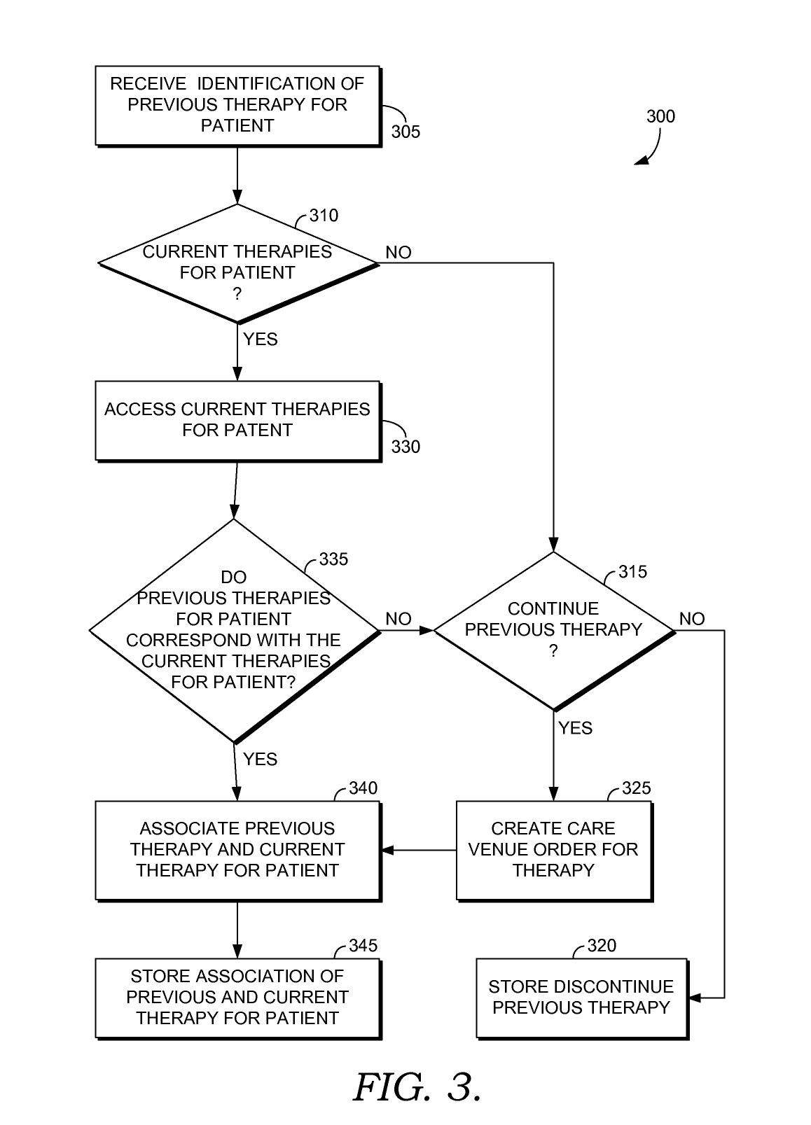

Referring next to FIG. 3, a method 300 is provided for creating associations between previous therapies for a patient and current care venue prescriptions for the patient. At step 305, identification of a previous therapy for a patient is received. As stated above, this information may be electronically input by a user, such as a caregiver, or may be electronically received. At step 310, it is determined if there are current therapies for the patient for the current care venue. If at step 310 it is determined that there are no current therapies for the patient for the current care venue, at step 315, it is determined whether the previous therapy should be continued or discontinued for the patient. This may be performed automatically utilizing a rules engine that creates new therapy orders for a therapy if certain criteria are satisfied. For example, a rule may exist to continue or discontinue all medication orders for a certain therapy if a patient has been prescribed with a certain disease or condition (e.g., heart condition). In another embodiment, a user, such as a caregiver, enters input to the computer system to continue or discontinue the previous therapy. If it is determined that the previous therapy should be discontinued, at step 320 the information to discontinue is stored for the patient.

If it is determined that the previous therapy is to be continued at the current care venue, at step 325, a new order for the therapy is created for the current care venue. At step 340, the previous therapy and the newly created order created for the current care venue are associated with one another. A prescription or ordering application, such as the EasyScript or PowerOrders solutions of Cerner Corporation of North Kansas City, Mo., may be utilized to help generate a new prescription order for the therapy for the patient. At step 345, the association and related information are stored for the patient.

Returning to step 310, if it is determined that one or more current care venue therapies exist for the patient, at step 330, the current therapies for the patient are accessed. This information may be accessed from a database containing patient information. At step 335, it is determined whether any of the current therapies for the patient at the care venue correspond with any previous therapies for the patient. If at step 335 it is determined that one or more previous therapies correspond with one or more current therapies for the patient, at step 340, the therapies are associated. This may be completed automatically based on a rules engine that identifies that a previous therapy and a current therapy are the same. Alternatively, a user may input information associating the previous therapy and the current therapy. At step 345, the association of the previous therapy and the current therapy is stored for the patient. This information may be utilized for treatment of the patient and/or for performing medication reconciliation for the patient.

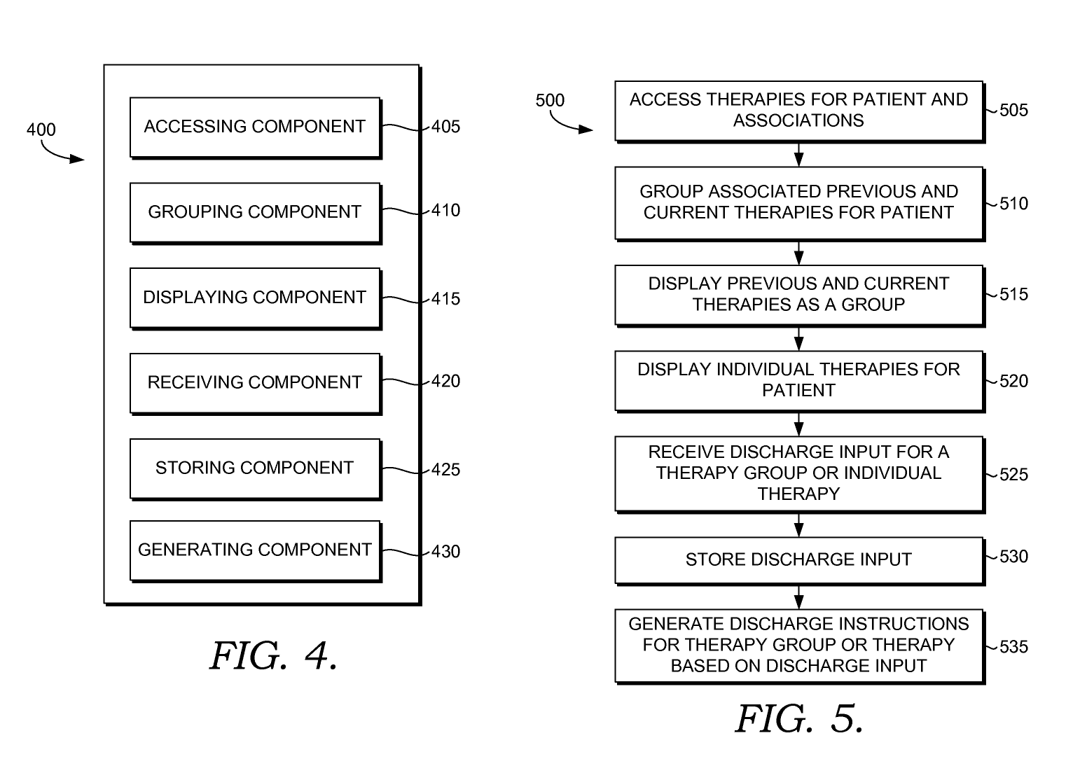

Referring next to FIG. 4, a block diagram is illustrated that shows exemplary computing system architecture configured for generating discharge instructions for previous therapies and current therapies for a patient. In performing medication reconciliation to discharge a patient, a caregiver chooses whether a patient should continue taking medications when the patient leaves the care venue, such as a hospital. It will be understood and appreciated by those of ordinary skill in the art that the computing system architecture shown in FIG. 4 is merely an example of one suitable computing system and is not intended to suggest any limitation as to the scope of use or functionality of the present invention. Neither should the computing system architecture 400 be interpreted as having any dependency or requirement related to any single module/component or combination of modules/components.

Computing system includes a therapy discharge module 400. Therapy discharge module 400 continues the continuum of therapy link by generating discharge instructions for previous therapies and current therapies for a patient. As stated above, previous therapies include therapies taken or prescribed prior to the patient's visit or admission to the current care venue. The current therapies for the patient are therapies that are taken and/or prescribed during the patient's current visit or admission to the current care venue.

Therapy discharge module 400 allows for discharge instructions to be provided to the patient for both the previous therapies and the current therapies. Therapy discharge module 400 may reside on one or more computing devices, such as, for example, computing device 100 described above with reference to FIG. 1. By way of example only and not limitation, computing devices may be a server, personal computer, desktop computer, laptop computer, handheld device, mobile handset, consumer electronic device, or the like. It should be noted, however, that embodiments are not limited to implementation on such computing devices, but may be implemented on any a variety of different types of computing devices within the scope of embodiments thereof.

Therapy discharge module 400 comprises an accessing component 405, grouping component 415, receiving component 420, storing component 425 and a generating component 430. Accessing component 405 receives or accesses one or more previous therapies taken and/or prescribed for the patient prior to visiting or being admitted to the current care venue and therapies prescribed and/or taken by the patient while visiting or being admitted to the current care venue. The previous therapies may have been electronically entered into the system by a caregiver into the therapy continuum module 200 of FIG. 2 or may been electronically transferred to the system. The previous therapy information may be gathered and entered as part of the medication reconciliation process. Accessing component 405 may access the patient's electronic medical to determine the current therapy orders for the patient at the current care venue. Examples of the orders include, but are not limited to, types of treatment or testing to be performed for a patient.

Grouping component 410 is configured for grouping therapies for a patient based on stored associations created and stored by associating component 215 and storing component 220 of FIG. 2. For example, if a previous therapy has been associated with a current therapy, grouping component 410 groups these therapies together to be displayed by displaying component 415.

Displaying component 415 is configured for electronically displaying the previous therapies for the patient and the current therapies for the patient. Displaying component 415 also is configured for displaying the groupings created by grouping component 410 comprising previous prescribed therapies for the patient associated with current therapies for the current care venue. Displaying component 415 is configured for displaying previous therapies for the patient and current therapies for the patient when the patient is being prepared for discharge from the current care venue. For example, a user may indicate to the system that the patient will be discharged at a certain time or is ready for discharge.

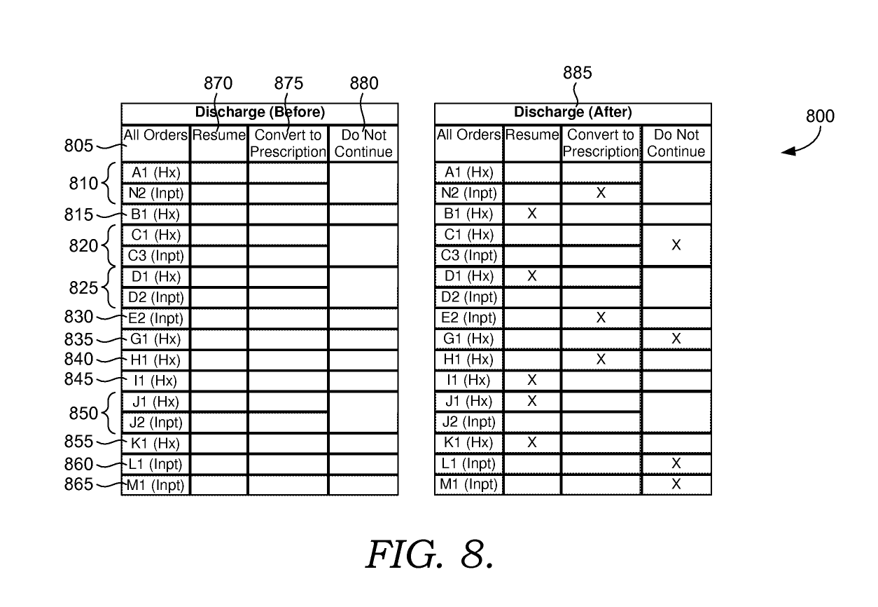

With reference to FIG. 8, illustrative interactive screen display 800 is shown. In accordance with an embodiment of the present invention, generally, exemplary user interface 800 comprises a list 805 of all medications prescribed and/or taken by the patient, including previous therapies and current therapies. When a patient is to be discharged or transferred from the current care venue a caregiver makes decisions pertaining to what therapies the patient needs to continue or discontinue upon discharge or transfer. In order to make these decisions in a safe manner the caregiver is provided with the previous therapies and current therapies for the patient. Interactive graphical user interface 800 provides therapy information for the patient in a readable manner and is therapeutically grouped so that a user can see what the patient was taking and/or prescribed and is currently taking and/or prescribed. The caregiver may then utilize this information to safely and accurately determine what therapies the patient should discontinue or continue upon discharge or transfer from the current care venue.

The user interface 800 provides a view of a patient's previous therapies, such as home medications, compared to what the patient is currently taking in their current venue of care. The therapies may be displayed in a therapeutic grouping allowing a user to additionally view other medications that are being taken within the same therapeutic grouping. This therapeutic grouping will help identify therapies that may be omitted, duplicated or conflict with other therapies. When performing medication reconciliation for discharge or transfer, the clinician may choose from user interface 800 whether the patient should continue taking each of the listed therapies.

In illustrative screen display 800, previous therapies that have been associated with current therapies are displayed together in a grouping, such as groupings 810, 820, 825, and 850. Current therapies 815, 835, 840, 845 and 855 that have not been associated with previous therapies are also displayed in illustrative screen display 800. Previous therapies 830, 860 and 865 for the patient that have not been associated with a current therapy are displayed in illustrative screen display 800. Interactive illustrative screen display 800 also includes user input areas 870, 875 and 880. A user may select from user input areas in columns 870, 875 and 880 whether to resume, convert therapy to a prescription or to discontinue the previous therapies and current therapies for a patient. For previous therapies that have not been associated with any current therapies, a user may select to resume 870 or discontinue 880 the previous prescription.

By way of example, and not by limitation, Mrs. Jones is a 45 year old female patient with a history of gastroesophageal reflux disease (GERD) and has been admitted for elective surgery to a hospital. Prior to admission, she was taking Zantac PO 300 mg QHS and Nexium 40 mg PO BID for the past 6 months. This information is taken from the patient by a nurse and input into the system as the patient's previous therapies. These previous therapies may be displayed, for example, in FIG. 6, as home medications. The treating physician determines that the patient's previous therapies need to be changed as Nexium nor Zantac are stocked by the hospital's pharmacy. Thus, from display 600 of FIG. 6 or another input screen, the treating caregiver may enter prescriptions for substitute therapies to treat Mrs. Jones for the same problem, GERD. The treating physician enters a prescription for Protonix 40 mg PO daily as a substitute for the previous therapy Nexium and enters a prescription for Pepcid 40 mg PO QHS as a substitute for the previous therapy Zantac. The Protonix and Pepcid will continue to treat Mrs. Jones' underlying condition of GERD during her stay. The treating caregiver may select to associate 630 the substitute therapy of Protonix for previous therapy Nexium and the substitute therapy for Pepcid for the previous therapy Zantac. As such, the previous and substitute therapies are linked and the relationship between them is stored to retain a continuum therapy link.

At the end of Mrs. Jones' stay at the hospital and when Mrs. Jones is ready for discharge, the previous therapies of Nexium and Zantac and the currently prescribed therapies for Pepcid and Protonix and their relationship are accessed from storage and are displayed to the discharging physician. All four therapies and the associations between them are displayed to the discharging physician so that the physician may determine the best course or treatment for the patient. The previous therapies, current therapies and the associations may be displayed, for example, in FIG. 8. The discharging physician enters input into display 800 as to whether Mrs. Jones should 1) start taking Pepcid and Protonix upon discharge 875, 2) resume her previous prescriptions for Nexium and Zantac 870 or 3) discontinue all medications for another course of treatment 880. In this example, the discharging physician decides to resume Nexium 40 mg PO BID but selects to convert the Pepcid 40 mg PO BID to a prescription and discontinue Mrs. Jones' use of Zantac as Pepcid is more cost effective for her.

For current therapies that have not been associated with any previous therapies for the patient, a user may select to convert 875 the therapy to a prescription for the patient to use at home or a different care venue, or the user may select to discontinue 880 the current therapy. For groupings of previous therapies that have been associated with a current therapy prescription, a user may select to resume 870 the previous therapy, convert 875 the current therapy into a prescription for the patient to use at home or a different care venue, or discontinue 880 the therapy altogether. The user selection is transferred to receiving component 420 of discharge therapy module 400 to be utilized by the storing component 425 and generating component 430 of FIG. 4.

Storing component 425 is configured for storing information associated discharge input for previously and current therapies for a patient. In various embodiments, such information may include, without limitation, current therapy orders for the patient, previous therapies for the patient, associations of previous therapy prescriptions and current venue therapy prescriptions, associations of previous therapy prescriptions and newly created therapy prescriptions for the current care venue, user selection to convert a current therapy into a prescription for the patient to use at home or a different care venue, and a user selection to discontinue current therapy or previous therapy.

An exemplary storing component is depicted by data store 14 of FIG. 1. In embodiments, the storage component 425 is configured to be searchable for one or more of the items stored in association therewith. It will be appreciated by those of ordinary skill in the art that the information stored in the storage component 425 may be configurable and may include a variety of information relevant to therapy prescriptions and discharge input. Further, though illustrated as a single, independent component, the storage component 425 may, in fact, be a plurality of storage devices, for instance a database cluster, portions of which may reside on the server 12 of FIG. 1, one or more end user devices 18, another external computing device (not shown), and/or any combination thereof.

Generating component 430 is configured for generating discharge instructions for previous therapies and/or current therapies for a patient upon discharge from the current care venue. Generating component 430 creates suggested prescription instructions based on the discharge input received. If the discharge input indicates that a previous therapy or current therapy for the patient should be discontinued, a discharge instruction is generated stating to discontinue the therapy should be discontinued. If the discharge input indicates that previous therapy for the patient should be resumed, discharge instructions indicating such are generated. These discharge instructions may also contain information regarding the prescription that is to be resumed including name of the therapy, frequency and dosage amount. If the discharge input indicates that a prescription for the patient to utilize at home or at the next care venue should be generated for a current therapy at the current care venue, the suggested discharge instructions create a suggested prescription along with a suggested dosage. A prescription application, such as the EasyScript solution of Cerner Corporation of Kansas City, Mo. may be utilized to help generate a suggested prescription for the patient. The discharge instructions for the patient may be stored and/or displayed. In one embodiment, once a patient is finally discharged, the follow-up physicians may receive a fax including the suggested discharge instructions. In another embodiment, the suggested discharge instructions are printed for the patient and the information is stored in the patient's electronic record. In another embodiment, a new prescription may be electronically transferred or faxed to a pharmacy to be filled.

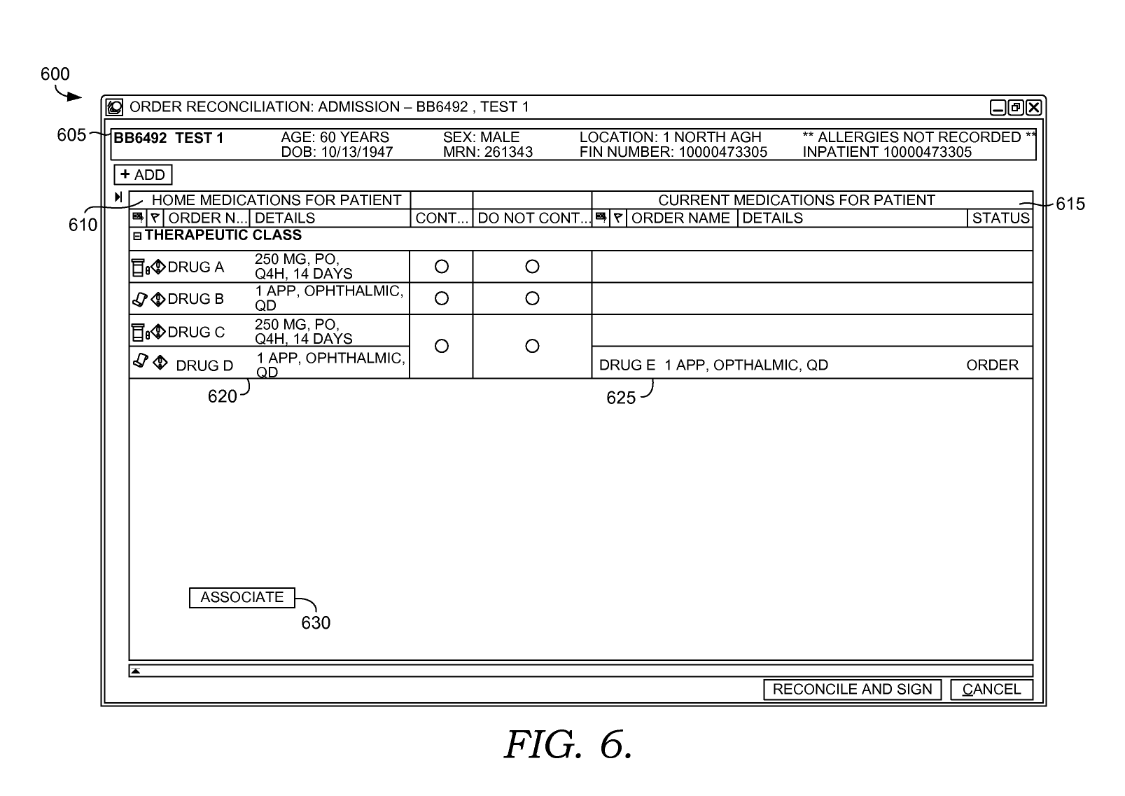

With reference to FIG. 5, a method 500 is provided for generating discharge instructions for previous therapies and current therapies for a patient. At step 605, therapies for the patient and any associations between therapies are accessed. These may be accessed from a database or table. In one embodiment, the database includes a patient's electronic medical record. The therapies may be current orders for the care venue or previous therapies for the patient that were electronically input by a user, such as a caregiver, or electronically received. At step 510, the associated therapies for the patient are grouped. For example, previous therapies that have been associated with a current therapy are grouped together.

At step 515, the therapies for the patient are displayed as a group, and the ungrouped therapies are displayed individually at step 520. FIG. 8 depicts therapies displayed as a group and individually. In one embodiment, the grouped therapies and the individual therapies are displayed simultaneously so that a caregiver can see all therapies for the patient.

At step 525, discharge input for grouped and/or individual therapies is received. The discharge input may be input by a user, such as a caregiver. The discharge input may include resuming a previous therapy, discontinuing a previous and/or current therapy and generating a new prescription for a current therapy. At step 530, the discharge input is stored in a database. In one embodiment, the database includes the patient's electronic medical record. At step 535, the discharge input received for the therapies is utilized to generate discharge instructions for the prescribed therapies to be provided to a patient or the next caregiver.

The present invention has been described in relation to particular embodiments, which are intended in all respects to illustrate rather than restrict. Alternative embodiments will become apparent to those skilled in the art that do not depart from its scope. Many alternative embodiments exist, but are not included because of the nature of the invention. A skilled programmer may develop means for implementing the aforementioned improvements without departing from the scope of the present invention.

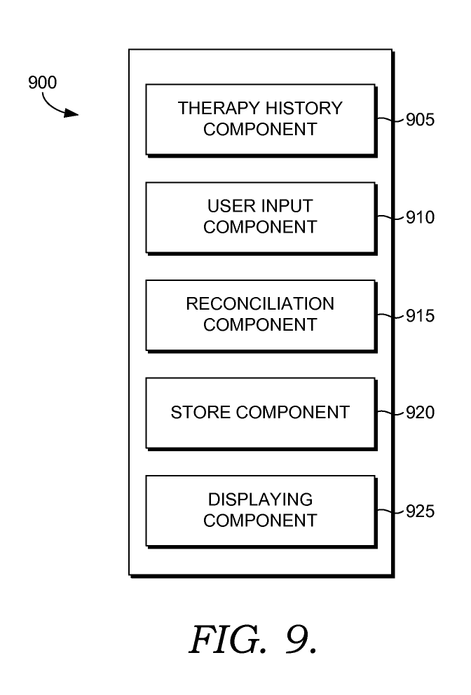

Referring next to FIG. 9, a block diagram is illustrated that shows exemplary computing system architecture configured for storing and displaying patient therapy reconciliation. Therapies include any form of treatment for any problem, diagnosis, illness or disorder including, but not limited to, prescription medications, over the counter medications, physical therapy treatment, occupational therapy treatment, respiratory therapy treatment, speech therapy treatment, and the like. It will be understood and appreciated by those of ordinary skill in the art that the computing system architecture shown in FIG. 9 is merely an example of one suitable computing system and is not intended to suggest any limitation as to the scope of use or functionality of the present invention. Neither should the computing system architecture be interpreted as having any dependency or requirement related to any single module/component or combination of modules/components.

The computing system includes a therapy reconciliation module 900. Therapy reconciliation module 900 allows a user to perform and store therapy reconciliation. Therapy history component 905 of the therapy reconciliation module 900 generates alerts that a therapy history, such as a mediation history, for the patient needs to be obtained by the caregiver. For example, when a patient visits and/or is admitted to a care venue, such as a hospital, an electronic task or alert is generated by the therapy history component 905 to notify a caregiver, such as a nurse, that a therapy history needs to taken for the patient. By way of example, a caregiver, such as a nurse, may electronically enter home medications for patient upon admission to the current care venue or later upon learning of the information while the patient is being treated at the current care venue. For example, the caregiver may ask the patient, the patient's family or patient's friends to identify the medications the patient has been taking (and/or has been prescribed) before the patient was admitted to the current care venue. The caregiver inputs the therapies utilizing user input component 910 that may be stored in storing component 920, such as the patient's electronic medical record. The previous therapy information may be gathered and entered as part of the medication reconciliation process.

The alert or notification that a patient therapy history needs to be completed may be displayed by displaying component 925 in a variety of ways including on a task list for the caregiver or in the patient activity list (PAL) that lists tasks the need to be performed by the caregiver for the patient. The status of a therapy history may also be displayed in an ordering application, such as a medication ordering application, as completed or uncompleted. Once the patient therapy history information, such as a list of previous medications, has been entered into the system, the caregiver may select that the therapy history has completed.

In one embodiment, the caregiver may only be able to take and enter a partial therapy history. For example, the name of a medication or other information may not be available at the time a nurse takes a patient's therapy history. The nurse may enter the information into the system and mark that the therapy history has only been partially completed. This may generate a reminder task or alert by therapy history component 905 to notify the caregiver or subsequent caregiver to complete the therapy history when the information can be obtained. For example, a nurse may need to wait until a family member arrives at the care venue to provide the needed information for the therapy history. Once this information is collected and entered by a caregiver utilizing user input component 910, the caregiver may indicate to the system that the patient's therapy history has been completed. Once the therapy history has been completed, the therapy reconciliation process may be completed by another caregiver, such as a physician or physician's assistant.

By way of example, and not by limitation, fictitious Alex Williams is a thirty (30) year old male that presents to the emergency department. He is unconscious as the result of a motor vehicle accident. Displaying component 925 displays an alert or notification generated by the therapy history component 905 that a therapy history is needed for the patient. Since the patient's identity is known but arrives alone, a history of medications the patient is taking can not be obtained at this time. Roberta Williams, Alex's wife is notified and will be arriving within the hour. Utilizing user input component 910, the nurse selects to delay collecting and inputting Alex's home medications until his wife arrives. In response, therapy history component 905 creates a reminder in Alex's electronic patient record that the medication history task has been delayed for completion possibly by someone else at a later time. When Alex's wife arrives, a notification or alert is displayed to the treating nurse by displaying component 925 that the therapy history task still needs to be completed. The treating nurse begins inputting Alex's therapy history utilizing user input component 910, however is interrupted as Alex is in process to move to the ICU. The treating nurse is able to input one home medication for Alex and then inputs into Alex's record that the therapy history task is still incomplete. Upon Alex's arrival in the ICU, the ICU nurse is notified by displaying component 925 that the therapy history task is still incomplete. The ICU nurse collects the rest of Alex's home medications from his wife and inputs the information using user input component 910. At this time the ICU nurse marks the therapy history task as being completed as all known home medications or previous therapies for the patient have been collected. The therapy history information entered into therapy history component 905 is stored by storing component 920 and may be utilized by reconciliation component 915 and other caregivers to complete the medication reconciliation process.

Reconciliation component 915 is configured for providing caregivers with a side-by-side view of patient's previous therapies, such as home medications, along with current or intended therapies ordered at the current care venue. The caregiver may then utilize this information to perform order or therapy reconciliation. The caregiver may view the list of previous therapies (e.g., entered utilizing therapy history component 905) and a list of currently prescribed therapies ordered at the current care venue displayed by display component 925. The caregiver, such as a physician, may then utilize this information to compare the previous therapies along with the currently ordered therapies and make clinical decisions based on the comparison. The caregiver can determine any omissions, duplications, dosing errors or drug interactions thus, performing medication reconciliation. The reconciliation information and decisions made by the caregiver may be entered into reconciliation component 915 utilizing user input component 910. Reconciliation component 915 aids caregivers in avoiding therapy omissions, duplications, dosing errors and drug interactions and improves communication across all caregivers involved in the patient's care.

In one embodiment, all of the previous and current therapies for the patient may be reconciled by a single caregiver, such as a physician. However, oftentimes the caregiver does not have a large block of time and/or the specific knowledge to reconcile all previous and current therapies displayed for a patient. Reconciliation component 915 allows therapy reconciliation to be performed by multiple users over multiple segments of time. If the caregiver is called away, the therapies/orders that have been reconciled are stored until the caregiver can return or another caregiver reconciles the remaining therapies/orders. The reconciliation component 915 stores the reconciliation as a partial complete that may be updated and/or changed a later time. In one embodiment, the reconciliation component 915 generates alerts or notifications reconciliation process needs to be completed. These notifications may be displayed utilizing display component 925 to one or more caregivers, notifying the caregiver that the therapy reconciliation process is not complete. Reconciliation component 915 allows multiple users throughout the patient's stay may perform therapy reconciliation utilizing the system.

Reconciliation component 915 also allows a caregiver to defer medication reconciliation decisions to another caregiver. Multiple physicians may be responsible for different therapies/orders for a patient in therapy reconciliation. For example, a cardiologist may reconcile the cardiac medications for the patient while the oncologist reconciles cancer therapies of the patient.

By way of example, and not by limitation, fictitious patient Justin Wells is a six year old boy with a known case of asthma is admitted to a children's hospital care venue for a tonsillectomy under Dr. Callahan's care. His pediatrician is Dr. Ellison who visits patients at the children's hospital. The patient's previous therapies include: albuterol 2 puff Q4 h PRN wheeze, montelukast 5 mg PO Daily, fluticasone 110 mcg/puff MDI 2 puff BID to treat his asthma. Justin has been currently prescribed while at the care venue a variety of pre-operative medications. The previous and current therapies are displayed by displaying component 925 to Dr. Callahan to perform therapy reconciliation. Since Dr. Callahan is an ENT surgeon and is uncomfortable addressing the three asthma medications Justin is taking, but is comfortable addressing any of his inpatient pre-op medications such as sedatives, Dr. Callahan utilizes user input component 910 to input reconciliation information for the pre-operative medications and chooses to defer the three asthma medications to Dr. Ellison or a member of his group. Dr. Callahan inputs his electronic signature for reconciling the pre-operative medications but the reconciliation is not complete as the three asthma medications still need reconciliation. The reconciliation component 915 generates a notification or alert for Dr. Ellison or someone from his group to reconcile the patient's three asthma medications. Once Dr. Ellison or someone from his group inputs the reconciliation information for the three asthma medications, the reconciliation is complete then Dr. Callahan could defer this to a pediatric service for someone from the service to address. In one embodiment, Dr. Callahan could defer to party unknown in order for another party to determine and enter the appropriate provider who should reconcile the remaining therapies.

Storing component 920 stores the reconciliation information entered by the caregiver, any information regarding deference, the status of the reconciliation (complete or incomplete), and the caregiver responsible for the reconciliation information. This allows for other providers to understand the current therapy intent for the patient as well as previous actions by other providers. Furthermore, this ensures that the management of therapy is not duplicated or unintentionally changed by another provider. The information stored by storing component 920 may be displayed by displaying component 925 to other providers so that they can see the history of the therapy reconciliation.

It will be understood that certain features and sub-combinations of utility may be employed without reference to features and sub-combinations and are contemplated within the scope of the claims. Furthermore, the steps performed need not be performed in the order described.

The invention claimed is:

1. A computer-implemented method for generating discharge instructions for a therapy grouping, the method comprising:
displaying a therapy grouping for a patient being discharged from a current care venue, the therapy grouping comprising a therapy prescribed for or taken by the patient prior to visiting a current care venue and an associated therapy the patient is taking or has been prescribed by the current care venue for the current care venue visit;
receiving a discharge input from a user for the therapy grouping;
generating discharge instructions for the therapy grouping for the patient based on the discharge input received; and
storing the discharge instructions for the therapy grouping for the patient.

2. The method of claim 1, wherein the discharge input comprises one of:
discontinuing the prior therapy and the current therapy;
continuing the prior therapy; and
converting the current therapy to a prescription for use outside of the current care venue.

3. The method of claim 3, wherein the discharge instructions comprise one of:
an instruction to discontinue the prior therapy and the current therapy;
an instruction to continue the prior therapy; and
a prescription for the current therapy for use outside the current care venue.

4. The method of claim 3, further comprising:
providing the patient with the discharge instructions for the therapy grouping.

5. The method of claim 4, further comprising:
accessing the prior therapy, the current therapy and the association of the prior and current therapies from the patient's electronic medical record.

6. The method of claim 5, wherein the one or more therapies a patient was taking or prescribed prior to visiting the current care venue comprise home medications.

7. The method of claim 6, wherein the one or more therapies the patient is taking or has been prescribed at the current care venue comprise medication orders at the current care venue.

8. The method of claim 7, wherein the one or more home medications and the one or more medication orders are for different medications utilized for the same treatment purpose.

9. The method of claim 8, further comprising:
displaying the discharge instructions for the therapy grouping.

10. The method of claim 9, further comprising:
displaying one or more therapies prescribed for or taken by the patient prior to visiting the current care venue that have not been associated with any therapy the patient is taking or has been prescribed by the current care venue for the current care visit.

11. The method of claim 10, further comprising:
displaying one or more therapies the patient is taking or has been prescribed by the current care venue for the current care visit that have not been associated with any therapies prescribed for or taken by the patient prior to visiting the current care venue.

12. The method of claim 11, further comprising:
receiving a discharge input from a user for
(a) the one or more therapies prescribed for or taken by the patient prior to visiting the current care venue that have not been associated with any therapy the patient is taking or has been prescribed by the current care venue for the current care visit, and
(b) the one or more therapies the patient is taking or has been prescribed by the current care venue for the current care visit that have not been associated with any therapies prescribed for or taken by the patient prior to visiting the current care venue.

13. A user interface embodied on one or more computer-storage media, the user interface for displaying therapy groupings and individual therapies for a patient on a display, the user interface comprising:
at least one therapy grouping area comprising one or more therapy groupings for a patient being discharged from a current care venue, the therapy grouping comprising a therapy prescribed for or taken by the patient prior to visiting the current care venue associated with a therapy the patient was prescribed while visiting the current care venue,
at least one previous therapy area comprising an individual therapy prescribed for the patient prior to visiting a current care venue that has not been associated with a therapy the patient was prescribed while visiting the current care venue,
at least one current therapy area comprising an individual therapy prescribed for the patient while visiting the current care venue that has not been associated with a therapy prescribed for or taken by the patient prior to visiting the current care venue; and
at least one interactive user input area allowing a user to enter a discharge input for at least one therapy grouping.

14. The user interface of claim 13, wherein the discharge input comprises at least one of:
discontinuing the prior therapy and the current therapy;
continuing the prior therapy; and
converting the current therapy to a prescription for use outside of the current care venue.

15. The user interface of claim 13, wherein the at least one interactive user input area allows the user to enter a discharge input for the at least one prior individual therapy.

16. The user interface of claim 15, wherein the discharge input comprises at least one of:
discontinuing the prior individual therapy; and
continuing the prior individual therapy;

17. The user interface of claim 15, wherein the at least one interactive user input area allows a user to enter a discharge input for the at least one current individual therapy.

18. The user interface of claim 17, wherein the discharge input comprises at least one of:
discontinuing the current individual therapy; and
converting the current individual therapy to a prescription for use outside of the current care venue.

19. The user interface of claim 13, wherein the one or more therapies a patient was taking or prescribed prior to visiting the current care venue comprise home medications, and the one or more therapies the patient is taking or has been prescribed at the current care venue comprise medication orders at the current care venue.

20. One or more computer-storage media having computer executable instructions embodied thereon that, when executed, perform a method for generating discharge instructions for a therapy grouping, the method comprising:
displaying a therapy grouping for a patient being discharged from a current care venue, the therapy grouping comprising a home medication prescribed for or taken by the patient prior to visiting a current care venue and a medication order from the current care venue for the current care venue visit;
receiving a discharge input from a user for the therapy grouping;
generating discharge instructions for the therapy grouping for the patient; and storing the discharge instructions for the therapy grouping for the patient.
